(19) United States
(12) Patent Application Publication
(10) Pub. No.: US 2013/0038531 A1
(43) Pub. Date: Feb. 14, 2013

(54) CURSOR CONTROLLING SYSTEM AND APPARATUS

(71) Applicant: Chien-Ming CHEN, Taipei (TW)

(72) Inventor: Chien-Ming CHEN, Taipei (TW)

(73) Assignee: National Taipei University of Technology, Taipei (TW)

(21) Appl. No.: 13/206,771

(22) Filed: Aug. 10, 2011

(51) Int. Cl. G09G 5/08

(52) U.S. Cl. 345/158

(57) ABSTRACT

A cursor-controlling system or apparatus includes a sensing module, a displacement controlling module and a driving module. The sensing module is for receiving a force to generate an input signal. The displacement controlling module includes a first signal amplifying circuit for amplifying the input signal to generate a first amplified signal; a comparator for receiving the first amplified signal to generate a selected signal; a second signal amplifying circuit for amplifying the selected signal to generate a second amplified signal; a filtering circuit for filtering the second amplified signal to generate a filtered signal; a third signal amplifying circuit for amplifying the filtered signal to generate a displacement signal. The driving module is for receiving the displacement signal to control movement of a cursor.

### BACKGROUND OF THE INVENTION

(1) Field of the Invention

The invention relates to a cursor controlling system and apparatus, particularly to a cursor controlling system and apparatus adapted to be operated by human foot.

(2) Description of the Prior Art

Early disabled men lose many work chance because they can not control the activities of limbs and trunk or their joints becomes deformed. With the information era coming, computer makes people's daily life more and more convenient, but for most disabled men, it is rather inconvenient to handle computer.

To help the disabled men to handle computer, several control methods of the man-machine interface system have been developed in the world, such as hand joint control, voice control, electromyogram(EMG) behavior, shoulder control, gassing and so on. The common disadvantage among these control methods is that they are not capable of executing complex control behaviors, and they are also unable to control the computer conveniently and real-timely because the control signal needs complex identification and longer processing period.

To conquer these limits, the technology of using the movement of eyeball or the handwriting tools such as big keyboard, special mouse etc., to control the computer emerges as the times require, Therefore, persons with disabilities can accept education or work normally.

The special mouse includes a wireless head controlled mouse, an user-machine interface controlled by eye-ball etc., which can help person with hand disabilities to communicate with the world.

The wireless head controlled mouse is a mouse system controlled by head. The molding of the wireless head controlled mouse is like earphones to hang on the head for control the mouse. The movement of the wireless head controlled mouse is controlled by turning the head rightward, leftward, upward or downward.

The eyeball tracking system is most common, which is capable of controlling the cursor or keyboard of the computer by detecting the movement of the eyeball in real time.

However, except above control methods, the other region of the human body can be used to control the mouse. Thus, other types of mouse may be worthy of development.

### SUMMARY OF THE INVENTION

An exemplary embodiment of the invention provides a cursor-controlling system and apparatus capable of being operated more conveniently by foot for person with hand disabilities. The cursor-controlling system has a simple circuit structure, so that it can be manufactured easily and the cost is low.

The cursor-controlling system includes a sensing module, a displacement controlling module and a driving module. The sensing module is for receiving a force to generate an input signal. The displacement controlling module includes a first signal amplifying circuit for amplifying the input signal to generate a first amplified signal; a comparator for receiving the first amplified signal to generate a selected signal; a second signal amplifying circuit for amplifying the selected signal to generate a second amplified signal; a filtering circuit for filtering the second amplified signal to generate a filtered signal; a third signal amplifying circuit for amplifying the filtered signal to generate a displacement signal. The driving module is for receiving the displacement signal to control movement of a cursor.

The cursor-controlling apparatus includes a substrate, the abovementioned cursor-controlling system disposed on the substrate, and a package element located on the substrate to cover the cursor-controlling to system including the sensing module, the displacement controlling module, the driving module and the switch.

The advantage of the present system or apparatus is that it can be capable of executing complex control behaviors, and can control the computer conveniently and real-timely.

### BRIEF DESCRIPTION OF THE DRAWINGS

FIG. 1 is a block diagram showing a cursor-controlling system.

FIG. 2 is a block diagram showing a displacement controlling module of the cursor-controlling system.

FIG. 3 is a circuit diagram of the cursor-controlling system.

FIG. 4 is a sensing module of the cursor-controlling system.

FIG. 5 is a schematic view of a cursor-controlling apparatus.

FIG. 6 is a schematic view showing the inner structure of the cursor-controlling apparatus.

### DESCRIPTION OF THE PREFERRED EMBODIMENTS

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “coupled,” and variations thereof herein are used broadly and encompass direct and indirect connections, couplings, and mountings.

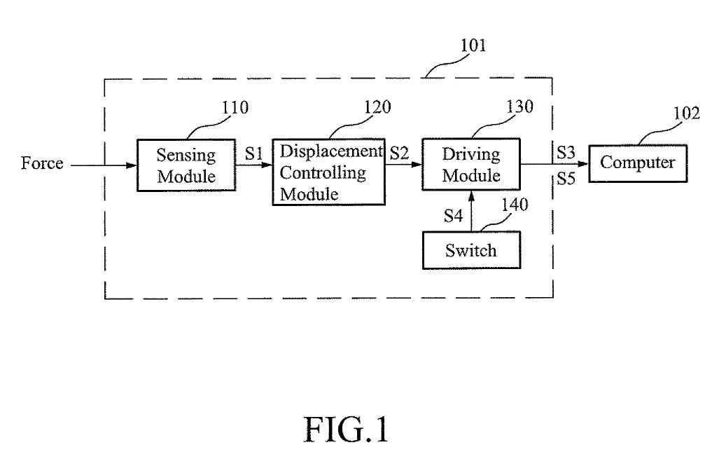

Refer to FIG. 1 for a block diagram of a cursor-controlling system. The cursor-controlling system 101 can be electrically connected to a computer 102 for operating the software installed in the computer 102 or peripheral devices connected with the computer 102, The cursor-controlling system 101 includes a sensing module 110, a displacement controlling module 120, a driving module 130 and a switch 140.

The sensing module 110 is capable of receiving a force to generate an input signal S1. The input signal S1 is transmitted to the displacement controlling module 120. After amplifying, comparing and filtering in the displacement controlling module 120, the input signal S1 is transformed into a displacement signal S2. The displacement signal S2 is transmitted from the displacement controlling module 120 to the driving module 130, and determines how long distance and in what direction the cursor moves. The driving module 130 transforms the displacement signal S2 into a first driving signal S3 for driving the movement of the cursor in the computer 102.

The switch 140 includes a left key and a right key for different functions. The S4 denotes an actuation signal generated by the action of the left or the right key and is also transmitted to the driving module 130. The driving module 130 transforms the actuation signal S4 into a second driving signal S5 to detonate the cursor, so as to command the computer 102 for executing a preset function.

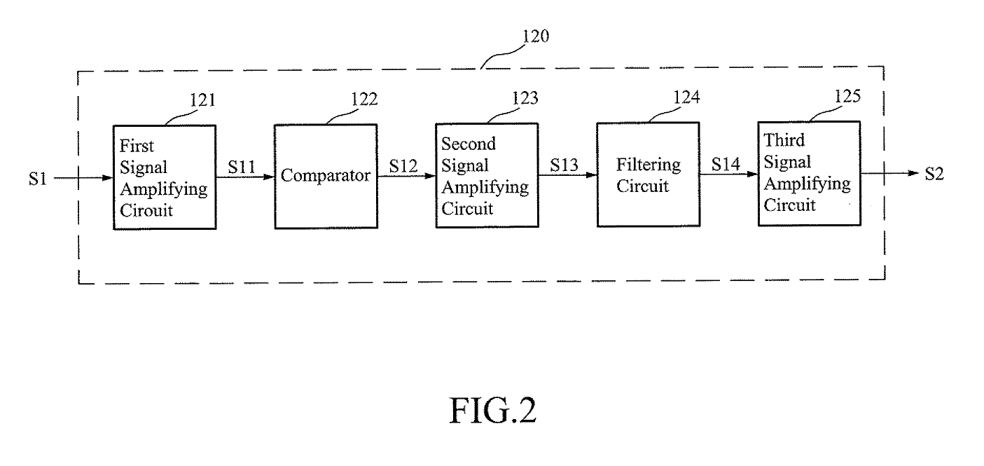

As shown in FIG. 2, the displacement controlling module 120 includes a first signal amplifying circuit 121, a comparator 122, a second signal amplifying circuit 123, a filtering circuit 124 and a third signal amplifying circuit 125 with serial connection in sequence. The first signal amplifying circuit 121 is for amplifying the input signal S1 to generate a first amplified signal S11. The comparator 122 is for receiving the first amplified signal S11 to generate a selected signal S12. The second signal amplifying circuit 123 is for amplifying the selected signal S12 to generate a second amplified signal S13. The filtering circuit 124 is for filtering the second amplified signal S13 to generate a filtered signal S14. The third signal amplifying circuit is for amplifying the filtered signal S14 to generate the displacement signal S2. And the driving module 130 is for receiving the displacement signal S2 to control movement of the cursor.

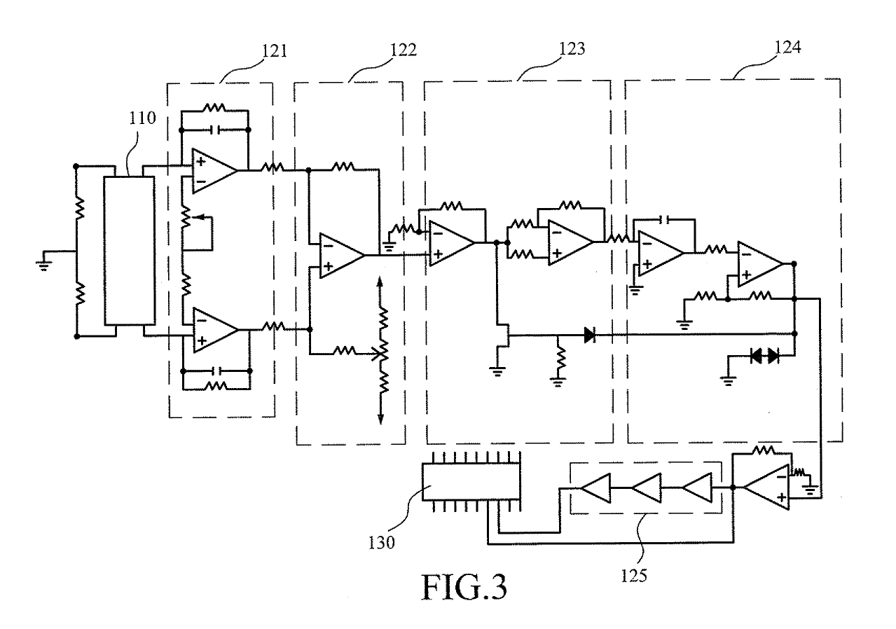

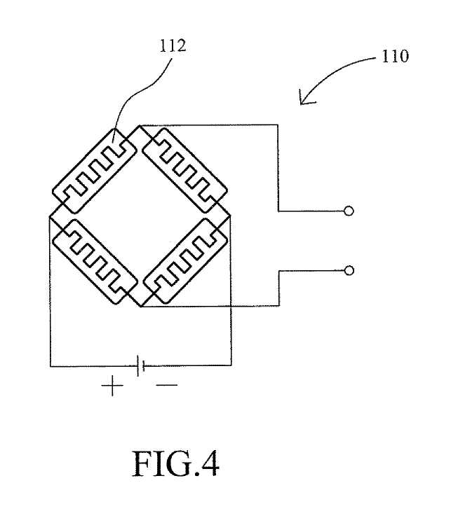

As shown in FIG. 3, the sensing module 110 is for example a single chip, or includes four strain gauges 112 formed as a bridge circuit (as shown in FIG. 4). The first signal amplifying circuit 121 has two operational amplifiers with parallel connection. The comparator 122 has only one operational amplifier. The second signal amplifying circuit 123 has two operational amplifiers with serial connection. The filtering circuit 124 has two operational amplifiers with serial connection. The third signal amplifying circuit 125 has a plurality of operational amplifiers with serial connection.

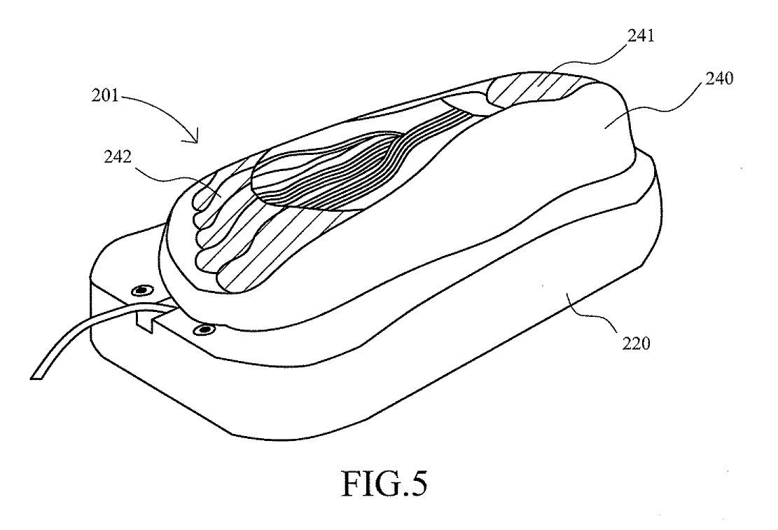

Refer to FIG. 5 for a schematic view of a cursor-controlling apparatus 201. The cursor-controlling apparatus 201 includes a substrate 220, the cursor-controlling system 101 and a package element 240. The package element 240 is made of silicon and molded into a footmark.

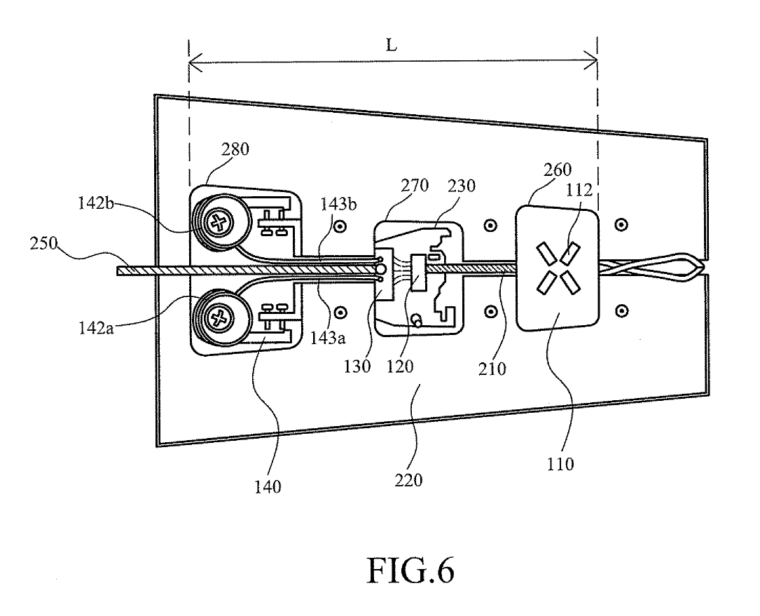

Referring to FIG. 6, in an exemplary embodiment, the substrate 220 has three fillisters 260, 270 and 280. There is a channel (not numbered) between the fillisters 260, 270 and 280. The sensing module 110 is disposed in the fillister 260. The driving module 130 and the displacement controlling module 120 are laid on the same print circuit board 230, and the print circuit board 230 is disposed in the faster 270. The switch 140 is disposed in the fillister 280. Thus, the sensing module 110, the displacement controlling module 120, the driving module 130 and the switch 140 are disposed on the substrate 220. The switch 140 and the sensing module 110 are located at different sides of the displacement controlling module 120.

The displacement controlling module 120 is electrically connected to the sensing module 110 through a line 210 which is located in the channel between the fillisters 260 and 270. The driving module 130 is electrically connected to the displacement controlling module 120. The switch 140 is electrically connected to the driving module 130 through lines 143a and 143b which are located in the channel between the fillisters 270 and 280. The driving module 130 is electrically connected to the computer 102 through a line 250 which is also located in the channel between the fillisters 270 and 280. The distance L between the sensing module 110 and the switch 140 is from 10 cm to 25 cm, which is about the length of a human foot.

The package element 240 is located on the substrate 220 and covers the sensing module 110, the displacement controlling module 120, he driving module 130 and the switch 140. Referring to FIG. 5 and FIG. 6, the heel portion 241 of the footmark is located corresponding to the switch 140, and the toe portion 242 of the footmark is located corresponding to the sensing module 110.

Below the heel portion 241 of the footmark, the switch 140 has two springs 142a and 142b which act as the right and left keys. When using the cursor-controlling apparatus 201, users press the strain gauges 112 by their toe on the toe portion 242, and then the sensing module 110 generates the input signal S1 for determine the direction and the displacement of the cursor due to the deformation of the strain gauges 112. The input signal S1 is transmitted to the displacement controlling module 120 through the line 210. The displacement controlling module 120 receives the input signal S1 and outputs the displacement signal S2 to the driving module 130. The driving module 130 receives the displacement signal S2 and outputs the first driving signal S3 to the computer 102 through the line 250, so that the cursor can be moved a certain distance in a certain direction to a desired position or an icon that represents some functions on the screen (not shown) of the computer 102.

If users want to execute the function of the icon when the cursor is located at the icon, they can press the spring 142a or 142b to turn on or off the switch 140, the actuation signals S4 generated from the springs 142a and 142b are transmitted to the driving module 130 through lines 143a and 143b, respectively. The driving module 130 receives the actuation signal S4 and outputs the second driving signal S5 to the computer 102 through the line 250.

In above embodiment, the displacement module 120 combines with the sensing module 110 make the cursor-controlling system 101 or apparatus 201 be capable of executing complex control behaviors, and can control the computer conveniently and real-timely.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A cursor-controlling system, comprising:
a sensing module, for receiving a force to generate an input signal;
a displacement controlling module, comprising:
a first signal amplifying circuit, for amplifying the input signal to generate a first amplified signal;
a comparator, for receiving the first amplified signal to generate a selected signal;
a second signal amplifying circuit, for amplifying the selected signal to generate a second amplified signal;
a filtering circuit, for filtering the second amplified signal to generate a filtered signal; and
a third signal amplifying circuit, for amplifying the filtered signal to generate a displacement signal; and
a driving module, for receiving the displacement signal to control movement of a cursor.

2. The cursor-controlling system of claim 1, wherein the first signal amplifying circuit comprises two operational amplifiers with parallel connection.

3. The cursor-controlling system of claim 1, wherein the second signal amplifying circuit comprises two operational amplifiers with serial connection.

4. The cursor-controlling system of claim 1, wherein the third signal amplifying circuit comprises a plurality of operational amplifiers with serial connection.

5. The cursor-controlling system of claim 1, wherein the filtering circuit comprises two operational amplifiers with serial connection.

6. The cursor-controlling system of claim 1, wherein the sensing module comprising a plurality of strain gauges formed as a bridge circuit.

7. The cursor-controlling system of claim 1, wherein the comparator comprises one operational amplifier.

8. A cursor-controlling apparatus, comprising:
a substrate;
a sensing module, disposed on the substrate;
a displacement controlling module, disposed on the substrate and electrically connected to the sensing module;
a driving module, disposed on the substrate and electrically connected to the displacement controlling module;
a switch, disposed on the substrate and electrically connected to the driving module, wherein the switch and the sensing module are located at different sides of the displacement controlling module; and
a package element, located on the substrate and covering the sensing module, the displacement controlling module, the driving module and the switch.

9. The cursor-controlling apparatus of claim 8, wherein the sensing module comprises four strain gauges formed as a bridge circuit.

10. The cursor-controlling apparatus of claim 8, wherein the switch has two springs.

11. The cursor-controlling apparatus of claim 8, wherein the package element is made of silicon.

12. The cursor-controlling apparatus of claim 8, wherein the package element is molded into a footmark.

13. The cursor-controlling apparatus of claim 8, wherein the distance between the sensing module and the switch is from 10 cm to 25 cm.

14. The cursor-controlling apparatus of claim 8, wherein the displacement controlling module comprises a first signal amplifying circuit, a comparator, a second signal amplifying circuit, a filtering circuit, and a third amplifying circuit with serial connection in sequence.

15. The cursor-controlling apparatus of claim 14, wherein the first signal amplifying circuit comprises two operational amplifiers with parallel connection.

16. The cursor-controlling apparatus of claim 14, wherein the second signal amplifying circuit comprises two operational amplifiers with serial connection.

17. The cursor-controlling apparatus of claim 14, wherein the third signal amplifying circuit comprises a plurality of operational amplifiers with serial connection.

18. The cursor-controlling apparatus of claim 14, wherein the filtering circuit comprises two operational amplifiers with serial connection.

19. The cursor-controlling apparatus of claim 14, wherein the comparator comprises one operational amplifier.
